(19) United States
(12) Patent Application Publication
(10) Pub. No.: US 2025/0187589 A1
(43) Pub. Date: Jun. 12, 2025

(54) METHOD AND APPARATUS FOR COOPERATIVE PARKING CONTROL CONSIDERING FAILURE OF RWS

(71) Applicants: Hyundai Motor Company, Seoul (KR); Kia Corporation, Seoul (KR)

(72) Inventors: Jun Wook Oh, Yongin-si (KR); Ki Ho Lee, Yongin-si (KR); Kyung Soo Ha, Hwaseong-si (KR)

(21) Appl. No.: 18/971,166

(22) Filed: Dec. 6, 2024

(30) Foreign Application Priority Data
Dec. 6, 2023 (KR) 10-2023-0175600

(51) Int. Cl. B60W 30/06; B60W 50/02

(52) U.S. Cl. CPC B60W 30/06; B60W 50/0205

(57) ABSTRACT

A method and apparatus for cooperative parking control can include considering a failure of a rear wheel steering (RWS) function for an ego vehicle. A cooperative parking control apparatus can include an error detection unit configured to detect whether an error is present in the RWS function, a route setting unit configured to set a parking route for the ego vehicle by using the rear wheel steering function based on the whether an error is present, and a parking control unit configured to perform parking control of the ego vehicle to follow the parking route by using a remote smart parking assistance function and the rear wheel steering function.

### CROSS-REFERENCE TO RELATED APPLICATIONS

This application claims priority to Patent Application No. 10-2023-0175600, filed on Dec. 6, 2023 in Korea, the entire contents of which are incorporated herein by reference.

### TECHNICAL FIELD

The present disclosure in some embodiments relates to a method and apparatus for cooperative parking control considering a failure of a rear wheel steering (RWS) function.

### BACKGROUND

The statements in this section merely provide background information related to the present disclosure and do not necessarily constitute prior art.

FIG. 1 is a diagram illustrating a conventional remote smart parking assist (RSPA) system in operation.

RSPA is a parking convenience function for enabling vehicle 100 to perceive a parking space based on vehicle sensors such as a wide-angle camera 101 and an ultrasonic sensor 102 and then automatically control the vehicle steering to complete parking within the parking space. The RSPA functions, during the automatic steering control, to perform an ultrasonic sensor-based perception of objects around the parking route and thereby provide route correction and collision prevention.

As shown in FIG. 1, in a conventional RSPA system, the RSPA function is activated by a driver operating an RSPA selection button in the vehicle 100 upon arrival at a reverse-allowed parking space.

When the cooperative control function is activated by the RSPA system, the vehicle sensor detects an available first parking space 111 as the vehicle 100 proceeds. At this time, when the driver presses an auto-parking button on a remote control, the RSPA function automatically steers the vehicle 100 to park autonomously in the first parking space 111 by controlling it in the process of \hat{1} reversing, \textcircled{2} forwarding, and \textcircled{3} reversing.

However, the existing cooperative RSPA control is implemented to be performed by considering only the presence of a front-wheel steering system by motor-driven power steering (MDPS) or electric power steering (EPS), with no consideration of the presence of a rear-wheel steering (RWS) function.

Accordingly, there is a need for cooperative RSPA control that further considers the RWS, and in particular, there is a need for a cooperative RSPA control function that even considers a failure of the RWS function.

### SUMMARY

An embodiment of the present disclosure can provide a cooperative parking control method and apparatus that accounts for RWS failures.

The advantages of an embodiment of the present disclosure are not necessarily limited to those particularly described herein, and other advantages that an embodiment of the present disclosure could achieve can be understood by those skilled in the art from the following detailed description.

According to at least one embodiment of the present disclosure, a cooperative parking control apparatus can include an error detection unit configured to detect whether an error is present in a rear wheel steering (RWS) function, a route setting unit configured to set a parking route for an ego vehicle by using the rear wheel steering function based on the whether an error is present, and a parking control unit configured to perform parking control of the ego vehicle to follow the parking route by using a remote smart parking assistance function and the rear wheel steering function.

According to an embodiment of the present disclosure, a cooperative parking control method can include performing error detection by detecting whether an error is present in an RWS function, performing route setting by setting a parking route for an ego vehicle by using the rear wheel steering function based on the whether an error is present, and performing a parking control of the ego vehicle to follow the parking route by using a remote smart parking assistance function and the rear wheel steering function.

According to embodiments of the present disclosure, by taking account of the RWS function in cooperative RSPA parking control, the turning radius can be reduced when parking, which can have the effect of shortening the parking time and improving the convenience of the driver.

Even in the event of an RWS failure, an embodiment of the present disclosure can enable parking control by reflecting the changed curvature without releasing the RSPA control due to the failure state.

The advantages of an embodiment of the present disclosure are not necessarily limited to those mentioned above, and other unmentioned advantages can be understood by those skilled in the art from the above description.

### BRIEF DESCRIPTION OF THE DRAWINGS

FIG. 1 is a diagram illustrating a conventional RSPA system in operation.

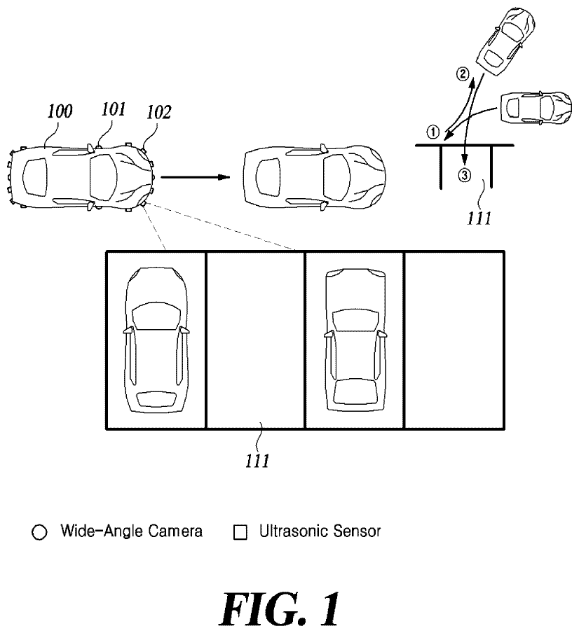

FIG. 2A is a block diagram of a cooperative parking control apparatus according to at least one embodiment of the present disclosure.

FIG. 2B is a diagram of the cooperative parking control apparatus along with a vehicle control unit and a sensing unit, according to at least one embodiment of the present disclosure.

FIG. 3A is a diagram illustrating an RWS function in operation whereby the rear wheel steering angle can be varied according to the speed of an ego vehicle, according to at least one embodiment of the present disclosure.

FIG. 3B is a diagram illustrating changes in the vehicle' driving curvature according to a driver's steering angle at a low speed, in the respective cases with and without a failure of the RWS function, according to at least one embodiment of the present disclosure.

FIG. 4 is a flowchart of a parking control process according to an embodiment of the present disclosure.

FIG. 5 is a flowchart of a parking control process according to an embodiment of the present disclosure.

FIG. 6 is a flowchart of a cooperative parking control method according to at least one embodiment of the present disclosure.

FIG. 7 is a block diagram schematically showing an example computing device that can be used to implement a method or apparatus according to an embodiment of the present disclosure.

### DETAILED DESCRIPTION OF ILLUSTRATIVE EMBODIMENTS

Hereinafter, some example embodiments of the present disclosure will be described in detail with reference to the accompanying drawings. In the following description, like reference numerals can designate like elements, although the elements can be shown in different drawings. Further, for the purpose of clarity and for brevity, the following description of some embodiments can omit a detailed description of related known components and functions when considered obscuring the subject of the present disclosure.

Various ordinal numbers or alpha codes such as “first,” “second,” “i),” “ii),” “a),” “b),” etc., can be prefixed to differentiate one component from the other but not necessarily to imply or suggest the substances, order, or sequence of the components. Throughout this specification, when a part “includes” or “comprises” a component, the part can be meant to further include other components, and to not exclude thereof unless specifically stated to the contrary. The terms such as “unit,” “module,” and the like can refer to units in which at least one function or operation is processed and they may be implemented by hardware, software, or a combination thereof.

The description of example embodiments of the present disclosure to be presented below in conjunction with the accompanying drawings is intended to describe example embodiments of the present disclosure and is not intended to represent the only possible embodiments in which technical ideas of the present disclosure may be practiced.

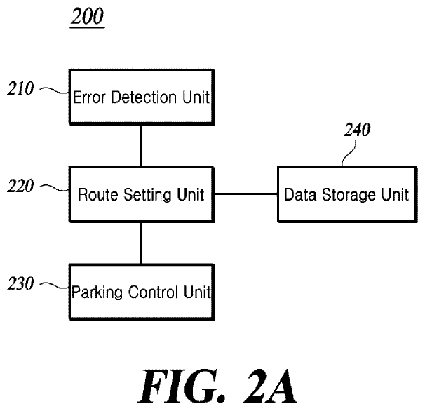

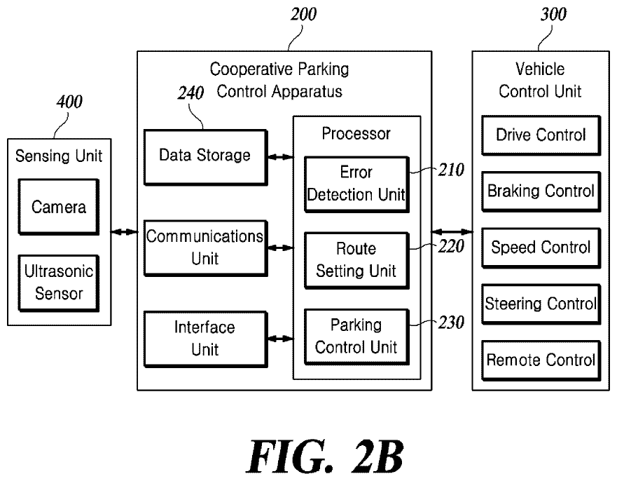

FIG. 2A is a block diagram of a cooperative parking control apparatus 200 according to at least one embodiment of the present disclosure.

The cooperative parking control apparatus 200 according to at least one embodiment includes an error detection unit 210, a route setting unit 220, a parking control unit 230, and a data storage unit 240, any of, any combination of, or all of which may be in plural or may include plural components thereof. Not all of the blocks shown in FIG. 2A and FIG. 2B are requisite components, and in other embodiments, some blocks included in the cooperative parking control apparatus 200 may be added, changed, or deleted. The components illustrated in FIGS. 2A and 2B represent functionally distinct elements, and at least one of the components may be implemented in a form that integrates in an actual physical environment.

The error detection unit 210 can detect whether there is a failure of the rear wheel steering (RWS) function of the ego vehicle.

The route setting unit 220 can set a parking route for the ego vehicle by using the rear wheel steering function based on whether the rear wheel steering function has failed.

The parking control unit 230 can perform parking control of the ego vehicle by using the RSPA function and the RWS function to follow the set parking route.

FIG. 2B is a diagram illustrating the cooperative parking control unit 200 along with a vehicle control unit 300 and a sensing unit 400.

The cooperative parking control apparatus 200 can perform parking control for controlling the vehicle control unit 300 by using the RSPA function and the RWS function.

The cooperative parking control apparatus 200 can perceive a parking space from detected data of the sensing unit 400 including a camera and an ultrasonic sensor, and store data necessary for parking control in the data storage unit 240. The function of the error detection unit 210, the function of the route setting unit 220, and the function of the parking control unit 230 can be incorporated in a processor that controls the vehicle control unit 300 by its drive control, braking control, transmission or speed control, steering control, and remote control to automatically steer the vehicle and thereby complete parking within the parking space.

The technical details of how the driver operates the remote control key fob to activate the RSPA (remote smart parking assist) function and how the cooperative parking control apparatus 200 controls the drive control, braking control, speed control, steering control, and remote control are off the main points of the present disclosure and will not be elaborated in more detail herein.

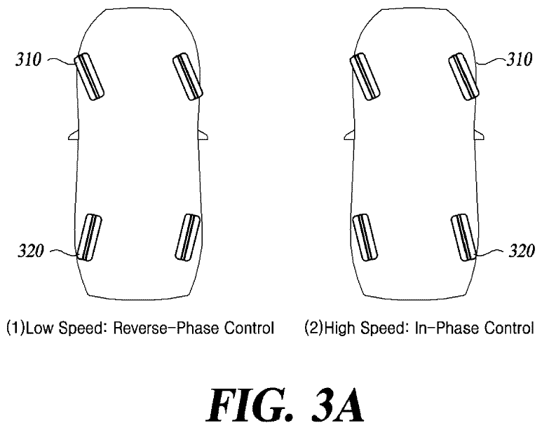

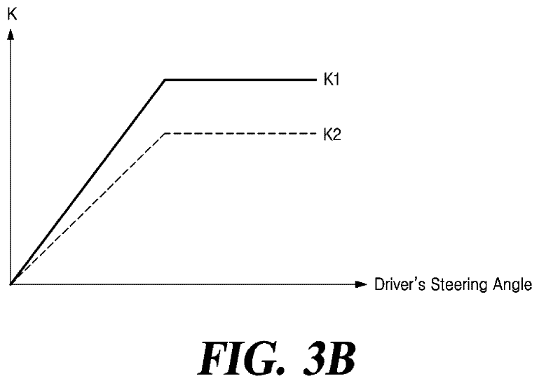

FIG. 3A is a diagram illustrating an RWS function in operation whereby the rear wheel steering angle can be varied according to the speed of an ego vehicle. FIG. 3B is a diagram illustrating changes in the vehicle' driving curvature according to a driver's steering angle at a low speed, in the respective cases with and without a failure of the RWS function.

As shown in FIG. 3A, the RWS function can perform reverse-phase control to steer the steering direction of the rear wheel 320 in a direction opposite to that of the front wheel 310 when the vehicle is at low speed, and in-phase control to steer the steering direction of the rear wheel 320 in the same direction as that of the front wheel 310 when the vehicle is at high speed.

The data storage unit 240 can store the graph as shown in FIG. 3B as data. The data stored in the data storage unit 240 can be used for route setting of the route setting unit 220.

As shown in FIG. 3B, at low speed, the magnitude of a first driving curvature change curve (K1) as a function of steering angle, when the RWS is not faulty, can be larger than the magnitude of a second driving curvature change curve (K2) occurring when the RWS fails. The second driving curvature change curve (K2), when the RWS fails, can refer to a neutral error in the rear wheel (e.g., rear wheels still oriented straight).

When applying RWS to a vehicle, in an embodiment, the rear wheel can perform a reverse-phase control in which the rear wheel is directed opposite to the front wheel, which can make the turning radius of the vehicle smaller and thereby exhibits relatively large curvature change curve (K).

Therefore, in an embodiment, parking using such a feature of the RWS can perform the controlled automatic parking by cooperative RSPA control more efficiently.

The error detection unit 210 can detect a rear-wheel steering function failure, including whether the rear wheel is in neutral and whether the rear wheel is skewed.

The error detection unit 210 can determine that the rear wheel is in a neutral error when the rear wheel is fixed in a neutral position.

If, at the time of the previous operation of the RWS function, the rear wheel was not steered and was in a state of immobility in the neutral position, the RWS function can store the neutral state information as the rear wheel state information that can be then obtained by the error detection unit 210 to determine that a neutral error has occurred in the rear wheel.

After the route setting unit 220 sets the parking route, in the process of following and controlling the parking route by the parking control unit 230, the error detection unit 210 may also be responsive to the rear wheel not steering and not moving from the neutral position during the operation of the RWS function, for determining that a neutral error has occurred in the rear wheel.

The error detection unit 210 can determine that a skew error has occurred in the rear wheel when the rear wheel is in a skewed state. The rear wheel being in a skewed state can refer to the rear wheel being deviated from its normal position (e.g., slightly turned or turned rather than straight).

When a skew error occurs in the rear wheel during the operation of the RWS function, the RWS function can store the skew error information as the rear wheel status information that can be then obtained by the error detection unit 210 to determine that a skew error has occurred in the rear wheel.

The error detection unit 210 can determine that a skew error has occurred in the rear wheel when it is skewed different from the normal orientation during the operation of the RWS function once the route setting unit 220 sets the parking route and the parking control unit 230 can control the parking route obeying.

The error detection unit 210 may be implemented to utilize various vehicle sensors for detecting various failure states of the rear wheel steering function in real-time.

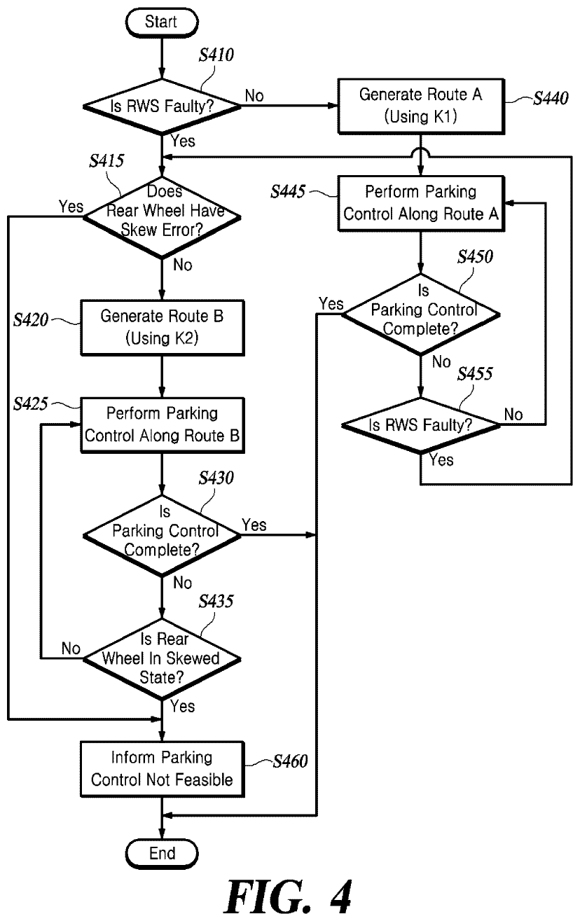

FIG. 4 is a flowchart of a parking control process according to a first example embodiment.

The error detection unit 210 can determine whether a failure has occurred in the RWS function (operation S410).

When the RWS function is not faulty in operation S410, the route setting unit 220 can generate a parking route (i.e., route A) for the ego vehicle by using the first driving curvature change curve K1 (operation S440). At this time, the route setting unit 220 can be responsive to a vehicle's turning route present in the parking route generated with the first driving curvature change curve K1, for setting the turning route by assuming that the rear wheel is controlled in reverse phase by the RWS function.

If operation S410 determines that a fault is present in the RWS function, the error detection unit 210 can determine whether a rear-wheel neutral error and/or a rear-wheel skew error occurred among RWS functional errors (operation S415).

If a rear-wheel skew error has occurred in operation S415, the parking control unit 230 can provide an audible message and/or a visual message to the user indicating that the parking control by cooperative RSPA control is not feasible and then end the parking control process (operation S460).

If operation S415 determines that a rear-wheel neutral error has occurred among the RWS functional errors, the route setting unit 220 can generate a parking route (i.e., route B) for the ego vehicle by using the second driving curvature change curve K2 (operation S420).

The parking control unit 230 can perform parking control of the ego vehicle by using the RSPA function to follow the set route B (operation S425). At this time, the parking control unit 230 can control the reverse parking of the ego vehicle to follow route B by sending a request command value to the braking control, drive control, steering control, speed control, etc. in the vehicle control unit 300.

While controlling the parking of the ego vehicle to follow route B in operation S425, the parking control unit 230 can check whether the parking control is completed (operation S430). At this time, if the parking control is completed, the parking control unit 230 can end the parking control process.

If operation S430 confirms that the parking control is not completed, the parking control unit 230 can call the error detection unit 210 and control the error detection unit 210 to re-detect whether the rear wheel is in a skewed state (operation S435).

If operation S435 confirms that the rear wheel is in a skewed state, the parking control unit 230 can provide an audible message and/or a visual message to the user indicating that the parking control by cooperative RSPA control is not feasible and then end the parking control process (operation S460).

When operation S435 confirms that the rear wheel is not in the skewed state, the parking control unit 230 can continue to perform parking control of the ego vehicle by using the RSPA function to follow route B (operation S425) and continue to check whether the parking control is completed (operation S430).

When operation S440 generates the parking route (i.e., route A), the parking control unit 230 can perform parking control of the ego vehicle by using the RSPA function and the RWS function to follow the set route A (operation S445). At this time, the parking control unit 230 can control the reverse parking of the ego vehicle to follow route A by sending a request command value to the braking control, drive control, steering control, speed control, etc. in the vehicle control unit 300.

While operation S445 performs the parking control on the ego vehicle to follow route A, the parking control unit 230 can check whether the parking control is completed (operation S450). At this time, if the parking control is completed, the parking control unit 230 can terminate the parking control.

If operation S450 confirms that the parking control is not completed, the parking control unit 230 can call the error detection unit 210 and control the error detection unit 210 to check whether a failure has occurred in the RWS function (operation S455).

If operation S455 confirms that a failure has occurred in the RWS function, the process can proceed to Step S415 where the error detection unit 210 can determine whether it is the rear-wheel neutral error and/or rear-wheel skew error among the RWS functional errors (operation S415).

When operation 410 determines that no failure occurs in the RWS function, the parking control unit 230 can perform the parking control along route A by using the RSPA function and the RWS function (operation S445).

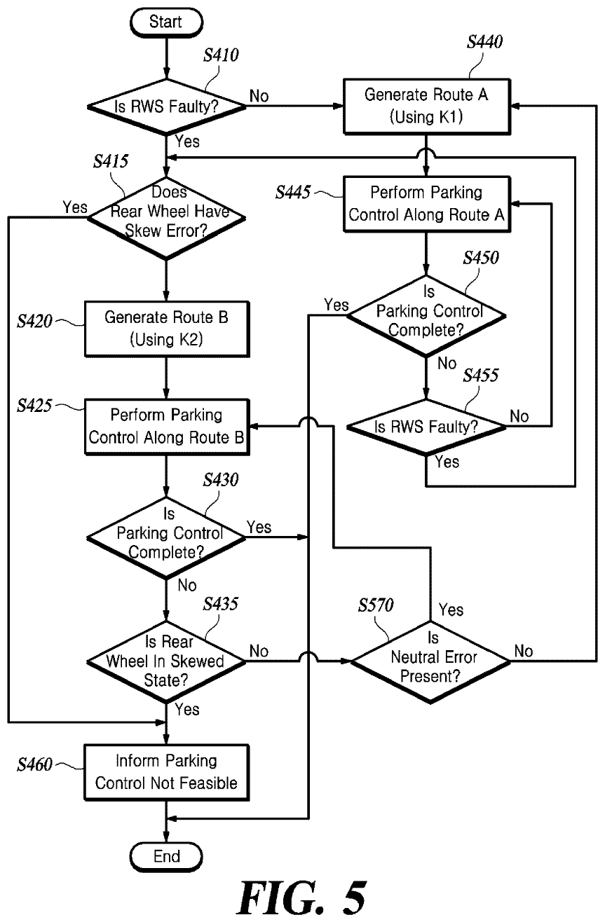

FIG. 5 is a flowchart of a parking control process according to a second example embodiment.

The parking control process according to the second example embodiment of FIG. 5 differs from the parking control process according to the first example embodiment of FIG. 4 in that an operation S570 is added and the process can proceed to operation S570 when operation S435 finds no rear-wheel skew error.

In FIG. 5, when operation S435 confirms that no rear-wheel skew error has occurred, the error detection unit 210 can recheck whether the rear wheel is in a neutral error (operation S570).

When operation S570 confirms that the rear wheel is not in a neutral error, the route setting unit 220 can generate a parking route (i.e., route A) for the ego vehicle by using the first driving curvature change curve K1 (operation S440), and the parking control unit 230 can perform parking control along the route A by using the RSPA function and the RWS function (operation S445).

If operation S570 confirms that the rear wheel is in a neutral error, the parking control unit 230 can continue to perform parking control along route B by using the RSPA function and the RWS function (operation S425).

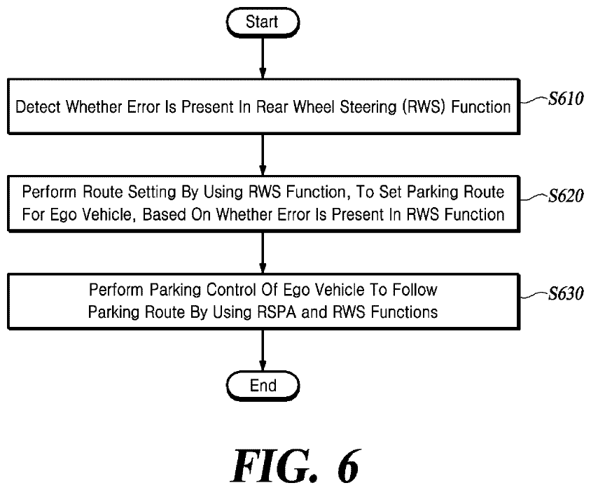

FIG. 6 is a flowchart of a cooperative parking control method according to at least one embodiment of the present disclosure.

The cooperative parking control method according to at least one embodiment of the present disclosure can be performed by the cooperative parking control unit 200.

The error detection unit 210 can perform an error detection process to detect whether an error is present in the RWS function (operation S610).

The route setting unit 220 can perform a route-setting process by using the RWS function, to set a parking route for the ego vehicle, based on whether an error is present in the RWS function (operation S620).

The parking control unit 230 can perform a parking control process for parking control on the ego vehicle to follow the parking route by using the RSPA function and the RWS function (operation S630).

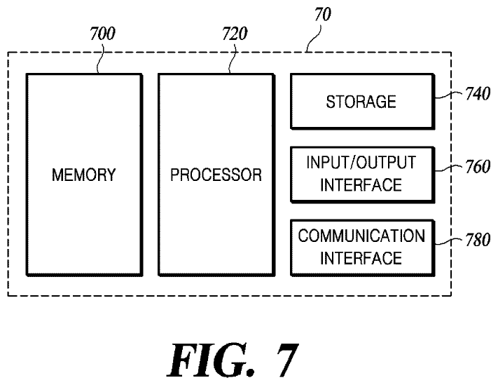

FIG. 7 is a block diagram schematically showing an example computing device that can be used to implement the method or apparatus according to the present disclosure.

The computing device 70 may include some or all of a memory 700, a processor 720, a storage 740, an input/output interface 760, and a communication interface 780, any of, any combination of, or all of which may be in plural or may include plural components thereof. The computing device 70 may structurally and/or functionally include at least a part of an error detection unit 210, a route setting unit 220, a parking control unit 230, and a data storage unit 240. The computing device 70 may be a stationary computing device such as a desktop computer, a server, and an AI accelerator, and may be a mobile computing device such as a laptop computer and a smartphone.

The memory 700 (or storage medium) may store a program that causes the processor 720 to perform method or operations according to various embodiments of the present disclosure. For example, the program may include a plurality of instructions executable by the processor 720, and the method shown in FIG. 6 may be performed by the processor 720 executing the plurality of instructions.

The memory 700 may be a single memory or a plurality of memories. Information required to perform methods or operations according to various embodiments of the present disclosure may be stored in a single memory or stored in a plurality of memories in a distributed manner, which can be referred to generally as a storage medium. When the memory 700 is configured as a plurality of memories, the plurality of memories may be physically separated.

The memory 700 may include at least one of a volatile memory and a non-volatile memory. The volatile memory includes a static random access memory (SRAM) or a dynamic random access memory (DRAM), and the non-volatile memory includes a flash memory.

The processor 720 may include at least one core capable of executing at least one instruction. The processor 720 may execute instructions stored in the memory 700. The processor 720 may be a single processor or a plurality of processors (together or separated).

The storage 740 can maintain stored data even if power supplied to the computing device 70 is cut off. For example, the storage 740 may include a non-volatile memory or may include storage media such as a magnetic tape, an optical disk, and a magnetic disk.

The program stored in the storage 740 may be loaded into the memory 700 before being executed by the processor 720. The storage 740 may store files written in a program language, and a program created from a file by a compiler or the like may be loaded into the memory 700. The storage 740 may store data to be processed by processor 720 and/or data processed by processor 720.

The input/output interface 760 may include an input device such as a keyboard and a mouse, and may include an output device such as a display device and a printer. A user 122 may trigger execution of a program by the processor 720 and/or check processing results of the processor 720 through the input/output interface.

The communication interface 780 may provide access to external networks. For example, the computing device 70 may communicate with other devices through the communication interface 780.

An apparatus or method according to an embodiment of the present disclosure may have the respective components arranged to be implemented as hardware or software, or hardware and software combined. Each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system can include at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) can contain instructions for a programmable processor and can be stored in a “computer-readable recording medium.”

The computer-readable recording medium can include any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Although the steps or operations in the respective flowcharts/timing charts are described to be sequentially performed, they merely instantiate the technical ideas of some embodiments of the present disclosure. Therefore, a person having ordinary skill in the pertinent art could perform the steps or operations by changing the sequences described in the respective flowcharts/timing charts or by performing two or more of the steps or operations in parallel, and hence the steps/operations in the respective flowcharts/timing charts are not necessarily limited to the illustrated chronological sequences.

Although example embodiments of the present disclosure have been described for illustrative purposes, those skilled in the art will appreciate that various modifications, additions, and substitutions can be possible, without departing from ideas and scopes of the present disclosure. Therefore, example embodiments of the present disclosure have been described for the sake of brevity and clarity. The scopes of technical ideas of embodiments of the present disclosure are not necessarily limited by the illustrations. Accordingly, one of ordinary skill can understand the scopes of the present disclosure are not to be necessarily limited by the above explicitly described example embodiments but by the claims and equivalents thereof.

What is claimed is:

1. An apparatus comprising:
at least one processor; and
a storage medium storing computer-readable instructions that, when executed by the at least one processor, enable the at least one processor to:
detect whether an error is present in a rear wheel steering (RWS) function of an ego vehicle,
set a parking route for the ego vehicle by using the RWS function based on whether the error is present, and
perform parking control of the ego vehicle to follow the parking route by using a remote smart parking assistance function and the RWS function.

2. The apparatus of claim 1, wherein the instructions further enable the at least one processor to set the parking route by detecting whether the error is present depending on whether a rear wheel of the ego vehicle deviates from a normal position.

3. The apparatus of claim 2, wherein the instructions further enable the at least one processor to stop the parking control in response to, as a result of detecting whether the error is present, the rear wheel having a skew error.

4. The apparatus of claim 2, wherein the instructions further enable the at least one processor to store a first magnitude of a first driving curvature change curve according to a steering angle by a driver with no failure occurring in the RWS function, and a second magnitude of a second driving curvature change curve according to the steering angle with a failure occurred in the RWS function.

5. The apparatus of claim 4, wherein the instructions further enable the at least one processor to generate the parking route by using the first driving curvature change curve in response to no failure occurring in the RWS function.

6. The apparatus of claim 4, wherein the instructions further enable the at least one processor to generate the parking route by using the second driving curvature change curve in response to a neutral error having occurred in the rear wheel.

7. The apparatus of claim 6, wherein the instructions further enable the at least one processor to perform the parking control along the parking route generated by using the second driving curvature change curve and continue to perform re-detecting whether the error is present.

8. The apparatus of claim 7, wherein the instructions further enable the at least one processor to stop the parking control in response to, as a result of the re-detecting of whether the error is present, the rear wheel having a skew error.

9. The apparatus of claim 7, wherein the instructions further enable the at least one processor to regenerate the parking route by using the first driving curvature change curve in response to, as a result of the re-detecting of whether the error is present, the rear wheel being confirmed to have neither a skew error nor the neutral error.

10. The apparatus of claim 2, wherein the instructions further enable the at least one processor to:
periodically check whether a failure of the RWS function has occurred while performing the parking control by using a first driving curvature change curve, and
in response to a neutral error being confirmed to have occurred in the rear wheel, stop the parking control and generate the parking route by using a second driving curvature change curve, wherein the second driving curvature change curve differs from the first driving curvature change curve.

11. A cooperative parking control method, comprising:
performing an error detection including detecting whether an error is present in a rear wheel steering (RWS) function of an ego vehicle;
performing a route setting including setting a parking route for the ego vehicle by using the RWS function based on whether the error is present; and
performing a parking control of the ego vehicle to follow the parking route by using a remote smart parking assistance function and the RWS function.

12. The method of claim 11, wherein the setting of the parking route comprises detecting whether the error is present depending on whether a rear wheel of the ego vehicle deviates from a normal position.

13. The method of claim 11, further comprising:
performing data storage including storing a first magnitude of a first driving curvature change curve according to a steering angle by a driver with no failure occurring in the RWS function, and a second magnitude of a second driving curvature change curve according to the steering angle with a failure occurred in the RWS function.

14. The method of claim 13, wherein the performing of the route setting comprises generating the parking route by using the second driving curvature change curve when a neutral error has occurred in the rear wheel.

15. The method of claim 14, wherein the performing of the parking control comprises performing the parking control along the parking route generated by using the second driving curvature change curve and continuing to perform re-detecting whether the error is present by using the performing of the error detection.

16. The method of claim 15, wherein the performing of the route setting comprises regenerating the parking route by using the first driving curvature change curve in response to, as a result of the re-detecting of whether the error is present, the rear wheel being confirmed to have neither a skew error nor the neutral error.

17. The method of claim 12, wherein the performing of the parking control comprises:
periodically checking whether a failure of the RWS function has occurred while performing the parking control by using a first driving curvature change curve, and
stopping the parking control in response to a neutral error being confirmed to have occurred in the rear wheel; and
wherein the performing of the route setting comprises, in response to the neutral error being confirmed to have occurred in the rear wheel, generating the parking route by using a second driving curvature change curve, wherein the second driving curvature change curve differs from the first driving curvature change curve.

18. A cooperative parking control method, comprising:
detecting whether an error is present in a rear wheel steering (RWS) function of an ego vehicle;
if the error is not detected in the RWS function, generating a first parking route using a first driving curvature change curve, and performing a first parking control of the ego vehicle using the first parking route and using the RWS function;
if the error is detected in the RWS function, determining whether the error is a skew error or a neutral error; and
if the error is detected in the RWS function as the neutral error, generating a second parking route using a second driving curvature change curve, and performing a second parking control of the ego vehicle using the second parking route and without using the RWS function, wherein the second driving curvature change curve differs from the first driving curvature change curve.

19. The method of claim 18, further comprising, if the error is detected in the RWS function as the skew error, informing a driver of the ego vehicle that no parking control can be performed.

20. The method of claim 18, further comprising:
during the performing of the first parking control of the ego vehicle using the first parking route and using the RWS function, determining whether the first parking control is complete; and
during the performing of the first parking control of the ego vehicle using the first parking route and using the RWS function, in response to the first parking control being not complete, determining again whether the error is present in the RWS function.
